(19) United States
(12) Patent Application Publication
(10) Pub. No.: US 2007/0112559 A1
(43) Pub. Date: May 17, 2007

(54) Audio signal synthesis

(75) Inventors: Erik Gosuinus Petrus Schuijers, Eindhoven (NL); Marc Willem Theodorus Klein Middelink, Eindhoven (NL); Arnoldus Werner Johannes Oomen, Eindhoven (NL); Leon Maria Van De Kerkhof, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA EINDHOVEN (NL)

(21) Appl. No.: 10/552,772

(22) PCT Filed: Apr. 14, 2004
(86) PCT No.: PCT/IB04/50436

§ 371 Date: Oct. 12, 2005

(30) Foreign Application Priority Data
Apr. 17, 2003 (EP) 03076134.0
Apr. 18, 2003 (EP) 03076166.2

(51) Int. Cl. G10L 19/02

(52) U.S. Cl. 704/203

(57) ABSTRACT

Synthesizing an output audio signal is provided on the basis of an input audio signal, the input audio signal comprising a plurality of input sub-band signals, wherein at least one input sub-band signal is transformed (T) from the sub-band domain to the frequency domain to obtain at least one respective transformed signal, wherein the at least one input sub-band signal is delayed and transformed (D, T) to obtain at least one respective transformed delayed signal, wherein at least two processed signals are derived from the at least one transformed signal and the at least one transformed delayed signal, wherein the processed signals are inverse transformed (T⁻¹) from the frequency domain to the sub-band domain to obtain respective processed sub-band signals, and wherein the output audio signal is synthesized from the processed sub-band signals.

The invention relates to synthesizing an audio signal, and in particular to an apparatus supplying an output audio signal.

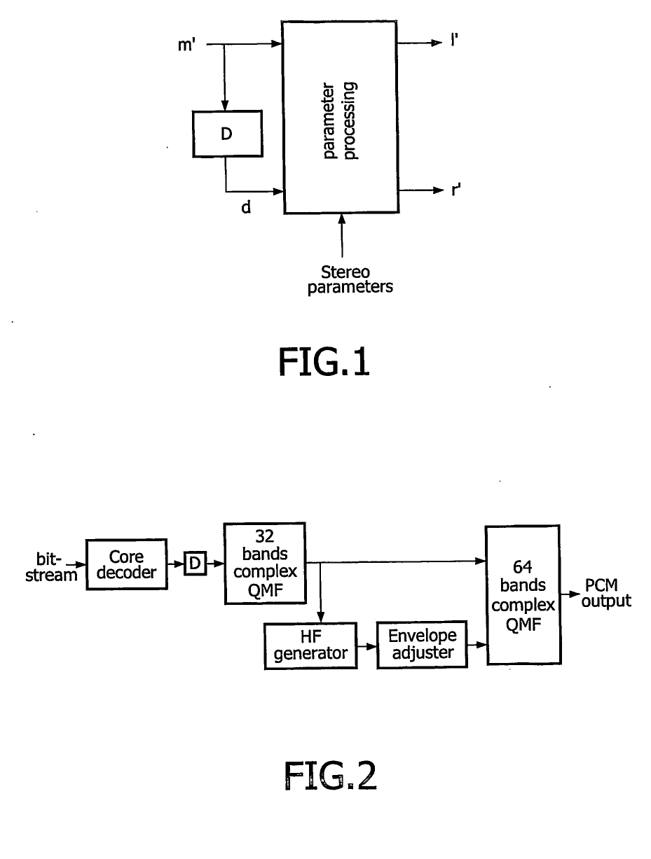

The article “Advances in Parametric Coding for High-Quality Audio”, by Erik Schuijers, Werner Oomen, Bert den Brinker and Jeroen Breebaart, Preprint 5852, 114th AES Convention, Amsterdam, The Netherlands, 22-25 Mar. 2003 discloses a parametric coding scheme using an efficient parametric representation for the stereo image. Two input signals are merged into one mono audio signal. Perceptually relevant spatial cues are explicitly modeled. The merged signal is encoded by using a mono-parametric encoder. The stereo parameters Interchannel Intensity Difference (IID), the Interchannel Time Difference (ITD) and the Interchannel Cross-Correlation (ICC) are quantized, encoded and multiplexed into a bitstream together with the quantized and encoded mono audio signal. At the decoder side, the bitstream is de-multiplexed to an encoded mono signal and the stereo parameters. The encoded mono audio signal is decoded in order to obtain a decoded mono audio signal m′ (see FIG. 1). From the mono time domain signal, a de-correlated signal is calculated by using a filter D 10 yielding optimum perceptual de-correlation. Both the mono time domain signal m′ and the de-correlated signal d are transformed to the frequency domain. Then the frequency domain stereo signal is processed with the IID, ITD and ICC parameters by scaling, phase modifications and mixing, respectively, in a parameter processing unit 11 in order to obtain the decoded stereo pair l′ and r′. The resulting frequency domain representations are transformed back into the time domain.

It is an object of the invention to advantageously synthesize an output audio signal on the basis of an input audio signal. To this end, the invention provides a method, a device, an apparatus and a computer program product as defined in the independent claims. Advantageous embodiments are defined in the dependent claims.

In accordance with a first aspect of the invention, synthesizing an output audio signal is provided on the basis of an input audio signal, the input audio signal comprising a plurality of input sub-band signals, wherein at least one input sub-band signal is transformed from the sub-band domain to the frequency domain to obtain at least one respective transformed signal, wherein the at least one input sub-band signal is delayed and transformed to obtain at least one respective transformed delayed signal, wherein at least two processed signals are derived from the at least one transformed signal and the at least one transformed delayed signal, wherein the processed signals are inverse transformed from the frequency domain to the sub-band domain to obtain respective processed sub-band signals, and wherein the output audio signal is synthesized from the processed sub-band signals. By providing a sub-band to frequency transform in a sub-band, the frequency resolution is increased. Such an increased frequency resolution has the advantage that it becomes possible to achieve high audio quality (the bandwidth of a single sub-band signal is typically much higher than that of critical bands in the human auditory system) in an efficient implementation (because only a few bands have to be transformed). Synthesizing the stereo signal in a sub-band has the further advantage that it can be easily combined with existing sub-band-based audio coders. Filter banks are commonly used in the context of audio coding. All MPEG-1/2 Layers I, II and III make use of a 32-band critically sampled sub-band filter.

Embodiments of the invention are of particular use in increasing the frequency resolution of the lower sub-bands, using Spectral Band Replication (“SBR”) techniques.

In an efficient embodiment, a Quadrature Mirror Filter (“QMF”) bank is used. Such a filter bank is known per se from the article “Bandwidth extension of audio signals by spectral band replication”, by Per Ekstrand, Proc. 1st IEEE Benelux Workshop on Model based Processing and Coding of Audio (MPCA-2002), pp.53-58, Leuven, Belgium, Nov. 15, 2002. The synthesis QMF filter bank takes the N complex sub-band signals as input and generates a real valued PCM output signal. The idea behind SBR is that the higher frequencies can be reconstructed from the lower frequencies by using only very little helper information. In practice, this reconstruction is done by means of a complex Quadrature Mirror Filter (QMF) bank. In order to efficiently come to a de-correlated signal in the sub-band domain, embodiments of the invention use a frequency (or sub-band index)-dependent delay in the sub-band domain, as disclosed in more detail in the European patent application in the name of the Applicant, filed on 17 Apr. 2003, entitled “Audio signal generation” (Attorney's docket PHNL030447). Since the complex QMF filter bank is not critically sampled, no extra provisions need to be taken in order to account for aliasing. Note that in the SBR decoder as disclosed by Ekstrand, the analysis QMF bank consists of only 32 bands, while the synthesis QMF bank consists of 64 bands, as the core decoder runs at half the sampling frequency compared to the entire audio decoder. In the corresponding encoder, however, a 64-band analysis QMF bank is used to cover the whole frequency range.

FIG. 2 is a block-diagram of a Bandwidth Enhanced (BWE) decoder using the Spectral Band Replication (SBR) technique as disclosed in MPEG-4 standard ISO/IEC 14496-3:2001/FDAM1, JTC1/SC29/WG11, Coding of Moving Pictures and Audio, Bandwidth Extension. The core part of the bitstream is decoded by using the core decoder, which may be e.g. a standard MPEG-1 Layer III (mp3) or an AAC decoder. Typically, such a decoder runs at half the output sampling frequency (fs/2). In order to synchronize the SBR data with the core data, a delay ‘D’ is introduced (288 PCM samples in the MPEG-4 standard). The resulting signal is fed to a 32-band complex Quadrature Mirror Filter (QMF). This filter outputs 32 complex samples per 32 real input samples and is thus over-sampled by a factor of 2. In the High-Frequency (HF) generator (see FIG. 1), the higher frequencies, which are not covered by the core coder, are generated by replicating (certain parts of) the lower frequencies. The output of the high-frequency generator is combined with the lower 32 sub-bands into 64 complex sub-band signals. Subsequently, the envelope adjuster adjusts the replicated high frequency sub-band signals to the desired envelope and adds additional sinusoidal and noise components as denoted by the SBR part of the bitstream. The total number of 64 sub-band signals is fed through the 64-band complex QMF synthesis filter to form the (real) PCM output signal.

Application of additional transforms, in a sub-band channel, introduces a certain delay. In sub-bands where no transform and inverse transform is included, delays should be introduced to keep alignment of the sub-band signals. Without special measures, the extra delay in the sub-band signals so introduced, results in a misalignment (i.e. out of sync) of the core and side or helper data such as SBR data or parametric stereo data. In the case of the sub-bands with additional transform/inverse transform and sub-bands without additional transform, additional delay should be added to the sub-bands without transform. Within SBR, the extra delay caused by the transforming and inverse transforming operation could be deducted from the delay D.

These and other aspects of the invention are apparent from and will be elucidated with reference to the embodiments described hereinafter.

In the drawings:

FIG. 1 is a block diagram of a parametric stereo decoder;

FIG. 2 is a block diagram of an audio decoder using SBR technology;

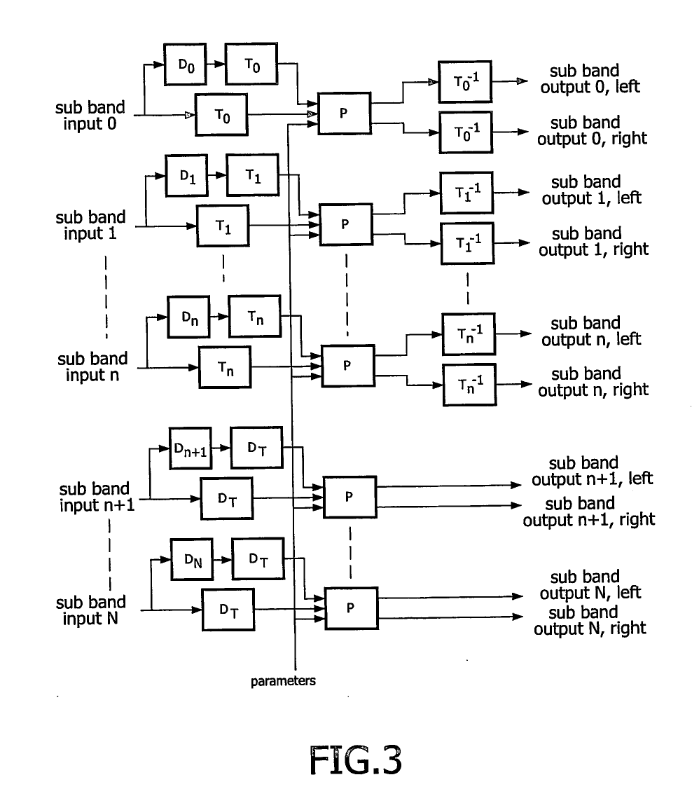

FIG. 3 shows parametric stereo processing in the sub-band domain in accordance with an embodiment of the invention;

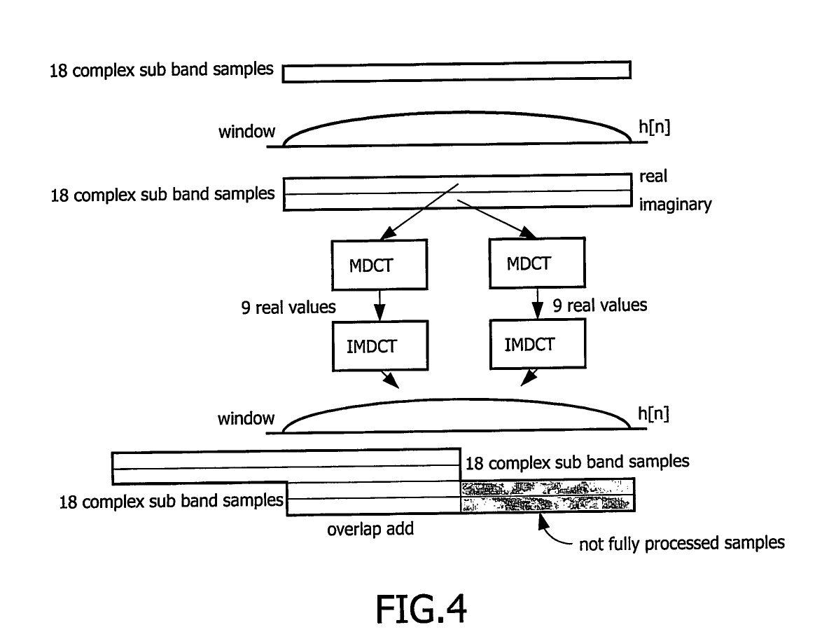

FIG. 4 is a block diagram illustrating the delay caused by transform-inverse transform TT⁻¹ of FIG. 3;

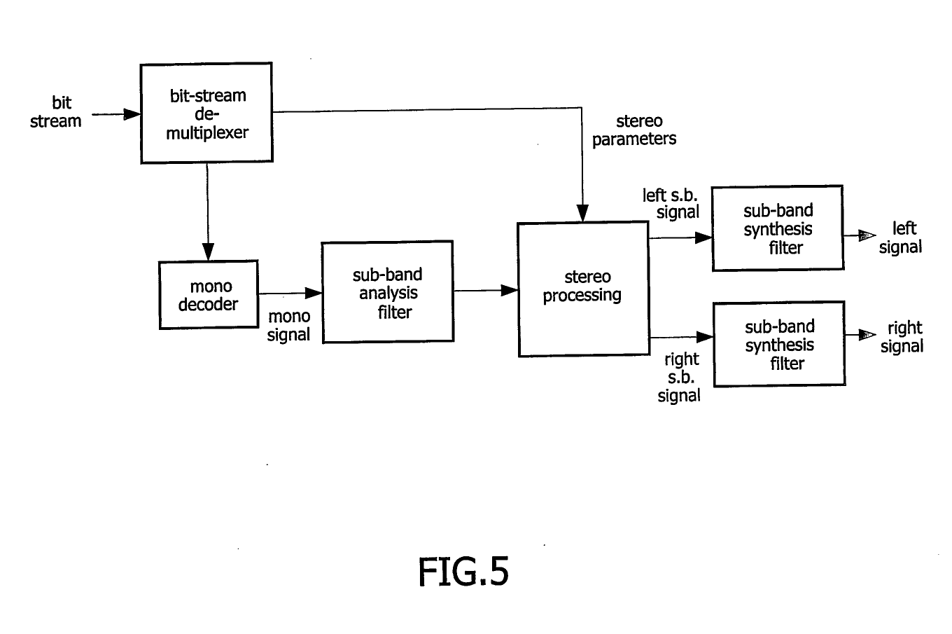

FIG. 5 shows an advantageous audio decoder in accordance with an embodiment of the invention, which provides parametric stereo, and

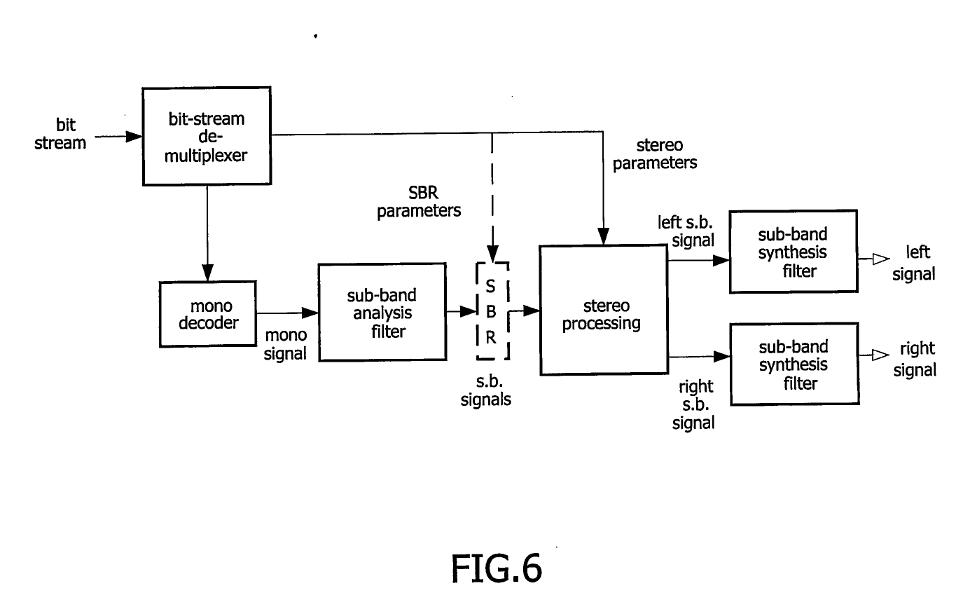

FIG. 6 shows an advantageous audio decoder in accordance with an embodiment of the invention, which combines parametric stereo with SBR.

The drawings only show those elements that are necessary to understand the invention.

FIG. 3 shows parametric stereo processing in the sub-band domain in accordance with an embodiment of the invention. The input signal consists of N input sub-band signals. In practical embodiments, N is 32 or 64. The lower frequencies are transformed, using transform T to obtain a higher frequency resolution, the higher frequencies are delayed, using delay D_{T} to compensate for the delay introduced by the transform. From each sub-band signal, also a de-correlated sub-band signal is created by means of delay-sequence Dₓ where x is the sub-band index. The blocks P denote the processing into two sub-bands from one input sub-band signal, the processing being performed on one transformed version of the input sub-band signal and one delayed and transformed version of the input sub-band signal. The processing may comprise mixing, e.g. by matrixing and/or rotating, the transformed version and the transformed and delayed version. The transform T⁻¹ denotes the inverse transform. D_{T} may be split before and after block P. Transforms T may be of different length, typically low frequency has a longer transform, which means that additionally a delay should also be introduced in the paths where the transform is shorter than the longest transform. The delay D in front of the filter bank may be shifted after the filter bank. When it is placed after the filter bank, it can be partially removed because the transforms already incorporate a delay. The transform is preferably of the Modified Discrete Cosine Transform (“MDCT”) type, although other transforms such as Fast Fourier Transform may also be used. The processing P does not usually give rise to additional delay.

FIG. 4 is a block diagram illustrating the delay caused by transform-inverse transform TT⁻¹ of FIG. 3. In FIG. 4, 18 complex sub-band samples are windowed by a window h[n]. The complex signals are then split into the real and imaginary part, which are both transformed, using the MDCT into two times 9 real values. The inverse transform of both sets of 9 values again leads to 18 complex sub-band samples that are windowed and overlap-added with the previous 18 complex sub-band samples. As illustrated in this Figure, the last 9 complex sub-band samples are not fully processed (i.e. overlap-added), leading to an effective delay of half the transform length, i.e. 9 (sub-band) samples. Consequently, the delay in a single sub-band filter should be compensated in all other sub-bands where no transformation is applied. However, introducing an extra delay to the sub-band signals prior to SBR processing (i.e. HF generation and envelope adjustment) results in a misalignment of the core and SBR data. In order to preserve this alignment, the PCM delay D as shown in FIG. 2 can be placed just after the M-band complex analysis QMF, which effectively results in a delay of D/M in each sub-band. Thus, the requirement for alignment of the core and SBR data is that the delay in all sub-bands amounts to D/M. Therefore, as long as the delay DT of the added transformation is equal to or smaller than D/M, synchronization can be preserved. Note that the delay elements in the sub-band domain become of the complex type. In practical SBR embodiments, M=32. M may also be equal to N.

Note that in practical embodiments, each transform T comprises two MDCTs and each inverse transform T⁻¹ comprises two IMDCTs, as described above.

The lower sub-bands, in which the transformation T is introduced, are covered by the core decoder. However, although they are not processed by the envelope adjuster of the SBR tool, the high-frequency generator of the SBR tool may require their samples in the replication process. Therefore, the samples of these lower sub-bands also need to be available as ‘non-transformed’. This requires an extra (again complex) delay of DT sub-band samples in these sub-bands. The mixing operation performed on the real values and on the complex values of the complex samples may be equal.

FIG. 5 shows an advantageous audio decoder in accordance with an embodiment of the invention, which provides parametric stereo. The bitstream is split into mono parameters/coefficients and stereo parameters. First, a conventional mono decoder is used to obtain the (backwards compatible) mono signal. This signal is analyzed by means of a sub-band filter bank splitting the signal into a number of sub-band signals. The stereo parameters are used to process the sub-band signals to two sets of sub-band signals, one for the left and one for the right channel. Using two sub-band synthesis filters, these signals are transformed to the time domain resulting in a stereo (left and right) signal. The stereo processing block is shown in FIG. 3.

FIG. 6 shows an advantageous audio decoder in accordance with an embodiment of the invention, which combines parametric stereo with SBR. The bitstream is split into mono parameters/coefficients, SBR parameters and stereo parameters. First, a conventional mono decoder is used to obtain the (backwards compatible) mono signal. This signal is analyzed by means of a sub-band filter bank splitting the signal into a number of sub-band signals. By using the SBR parameters, more HF content is generated, possibly using more sub-bands than the analysis filter bank. The stereo parameters are used to process the sub-band signals to two sets of sub-band signals, one for the left and one for the right channel. By using two sub-band synthesis filters, these signals are transformed to the time domain resulting in a stereo (left and right) signal. The stereo processing block is shown in the block diagram of FIG. 3.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the indefinite article “a” or “an” preceeding an element or step does not exclude the presence of a plurality of such elements or steps. Use of the verb ‘comprise’ and its conjugations does not exclude the presence of elements or steps other than those stated in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of synthesizing an output audio signal on the basis of an input audio signal, the input audio signal comprising a plurality of input sub-band signals, the method comprising the steps of:
transforming (T) at least one input sub-band signal from sub-band domain to frequency domain to obtain at least one respective transformed signal,
delaying (D_{0 . . . n}) and transforming the at least one input sub-band signal to obtain at least one respective transformed delayed signal;
deriving (P) at least two processed signals from the at least one transformed signal and the at least one transformed delayed signal,
inverse transforming (T⁻¹) the processed signals from frequency domain to sub-band domain to obtain respective processed sub-band signals, and
synthesizing the output audio signal from the processed sub-band signals.

2. A method as claimed in claim 1, wherein the transforming is a cosine transforming and the inverse transforming is an inverse cosine transforming.

3. A method as claimed in claim 1, wherein the input sub-band signals comprise complex samples and wherein a real value of a given complex sample is transformed in a first transform and a complex value of the given complex sample is transformed in a second transform.

4. A method as claimed in claim 3, wherein the first transform and the second transform are separate but equal transforms.

5. A method as claimed in claim 1, wherein the processing comprises a matrixing operation.

6. A method as claimed in claim 1, wherein the processing comprises a rotation operation.

7. A method as claimed in claim 1, wherein the at least one sub-band signal includes the sub-band signal having the lowest frequency.

8. A method as claimed in claim 7, wherein the at least one sub-band signal consists of 2 to 8 sub-band signals.

9. A method as claimed in claim 1, wherein the synthesizing step is performed in a sub-band filter bank for synthesizing a time domain version of the output audio signal from the processed sub-band signals.

10. A method as claimed in claim 9, wherein the sub-band filter bank is a complex sub-band filter bank.

11. A method as claimed in claim 9, wherein the complex sub-band filter bank is a complex Quadrature Mirror Filter bank.

12. A method as claimed in claim 1, wherein the input audio signal is a mono audio signal and the output audio signal is a stereo audio signal.

13. A method as claimed in claim 1, the method further comprising the step of:
obtaining a correlation parameter which is indicative of a desired correlation between a first channel and a second channel of the output audio signal, wherein the processing is arranged to obtain the processed signals by combining the transformed signal and the transformed delayed signal in dependence on the correlation parameter, and wherein the first channel is derived from a first set of processed signals and the second channel from a second set of processed signals.

14. A method as claimed in claim 13, wherein each processed signal comprises a plurality of output sub-band signals, and wherein a first time domain channel and a second time domain channel are synthesized on the basis of the output sub-band signals, respectively, preferably in respective synthesis sub-band filter banks.

15. A method as claimed in claim 1, wherein the method further comprises the steps of:
deriving M sub-bands to generate M filtered sub-band signals on the basis of a time domain core audio signal,
generating a high-frequency signal component derived from the M filtered sub-band signals, the high-frequency signal component having N−M sub-band signals, where N>M, the N−M sub-band signals including sub-band signals with a higher frequency than any of the sub-bands in the M sub-bands, the M filtered sub-bands and the N−M sub-bands together forming the plurality of input sub-band signals.

16. A device for synthesizing an output audio signal on the basis of an input audio signal, the input audio signal comprising a plurality of input sub-band signals, the device comprising:
means for transforming (T) at least one input sub-band signal from sub-band domain to frequency domain to obtain at least one respective transformed signal,
means for delaying (D_{0 . . . n}) and transforming the at least one input sub-band signal to obtain at least one respective transformed delayed signal;
means for deriving (P) at least two processed signals from the at least one transformed signal and the at least one transformed delayed signal,
means for inverse transforming (T⁻¹) the processed signals from frequency domain to sub-band domain to obtain respective processed sub-band signals, and
means for synthesizing the output audio signal from the processed sub-band signals.

17. An apparatus for supplying an output audio signal, the apparatus comprising:
an input unit for obtaining an encoded audio signal,
a decoder for decoding the encoded audio signal to obtain a decoded signal including a plurality of sub-band signals,
a device as claimed in claim 16 for obtaining the output audio signal on the basis of the decoded signal, and
an output unit for supplying the output audio signal.

18. A computer program product including a code for instructing a computer to perform the following steps:
transforming (T) at least one input sub-band signal from sub-band domain to frequency domain to obtain at least one respective transformed signal,
delaying (D_{0 . . . n}) and transforming the at least one input sub-band signal to obtain at least one respective transformed delayed signal;
deriving (P) at least two processed signals from the at least one transformed signal and the at least one transformed delayed signal,
inverse transforming (T⁻¹) the processed signals from frequency domain to sub-band domain to obtain respective processed sub-band signals, and
synthesizing the output audio signal from the processed sub-band signals.
